(19) United States
(12) Patent Application Publication
(10) Pub. No.: US 2019/0031147 A1
(43) Pub. Date: Jan. 31, 2019

(54) DEVICE FOR PROTECTING AN OPTICAL SENSOR AND DRIVING ASSISTANCE SYSTEM COMPRISING SUCH A DEVICE FOR PROTECTION

(71) Applicant: Valeo Systèmes d'Essuyage, Le Mesnil Saint Denis (FR)

(72) Inventors: Thierry Cheng, Le Mesnil Saint Denis (FR); Marcel Trebouet, Le Mesnil Saint Denis (FR)

(73) Assignee: Valeo Systèmes d'Essuyage, Le Mesnil Saint Denis (FR)

(21) Appl. No.: 16/042,329

(22) Filed: Jul. 23, 2018

(30) Foreign Application Priority Data
Jul. 27, 2017 (FR) 1757133

(51) Int. Cl. B60S 1/02; G02B 27/00; B60S 1/56; B60R 11/04

(52) U.S. Cl. CPC B60S 1/026; B60R 11/04; B60S 1/56; G02B 27/0006

(57) ABSTRACT

The subject of the present invention is a device (3) for protecting an optical sensor (13) of a driver-assistance system (1) for a motor vehicle, the optical sensor (13) comprising an optic (14), and the protecting device (3) including: an optical element (9) that is configured to be positioned upstream of the optic (14) of the optical sensor (13) and mounted so as to be movable about an axis of rotation (A1); and an actuator (5) that is configured to rotate the optical element (9), characterized in that the protecting device (3) further includes: at least one heating component (7) that is configured to heat the optical element (9) so as to defog or defrost this optical element (9); and an induction system (8) that is configured to supply power to the heating component (7).

The present invention relates to the field of driver assistance, and in particular to the driver-assistance systems that are incorporated in some vehicles. The driver-assistance system may include an optical sensor, such as for example a camera comprising an objective, in particular comprising at least one lens. More particularly, the invention relates to a device for protecting such an optical sensor.

Currently, many motor vehicles are equipped with front-, rear- or even side-view cameras. They in particular form part of driver-assistance systems, such as parking-assistance systems, or even systems for detecting lane departure.

Cameras that are installed in the interior of the passenger compartment of a vehicle against the rear windscreen/window and that point backward through the rear windscreen of the vehicle are known. These cameras are well protected from exterior climatic events and grime caused by organic or inorganic pollutants. Additionally, the optic of this camera may be defrosted or defogged by the defrosting system, which is in particular installed on the rear windscreen, of the motor vehicle. However, the angle of view for such cameras, installed in the interior of the passenger compartment, is not optimal, in particular for a parking-assistance system, for example because they do not allow obstacles located in proximity to the rear of the vehicle to be seen.

For this reason, it is preferred to install the cameras of driver-assistance systems on the exterior of vehicles in various locations depending on the desired use, for example level with the front or rear bumper, or else level with the front or rear number plate of the vehicle. In this case, the camera is therefore highly exposed to being spattered with organic or inorganic dirt that may be deposited on its optic and thus decrease its effectiveness, or even make it inoperative. In particular, during periods of wet weather, rain and dirt is observed to spatter, this spatter possibly greatly affecting the operability of the driver-assistance system comprising such a camera. The surfaces of the optics of the cameras must therefore be cleaned in order to guarantee they remain in a good operating state.

To counter the deposition of dirt on the camera, it is known to arrange a device for cleaning the optic of the camera, generally a sprayer of cleaning liquid, in proximity thereto, in order to remove the polluting elements that are deposited over time. However, the use of these sprayers leads to an increase in the operating cost of such a driver-assistance system because they require quite large amounts of cleaning liquid to be used. Furthermore, such a cleaning device does not combat the formation of condensation or frost in the field of view of the camera. However, the formation of condensation or frost in the field of view of the camera negatively affects the correct operation of the driver-assistance system.

According to one known solution, means for vibrating a protecting window of the camera are provided in order to shed dirt from the protecting window of the camera. However, it has been observed that the effectiveness of such a device for tenacious and encrusted grime may be limited despite the vibration of the protecting window. Additionally, such vibrating means do not effectively combat the formation of condensation or frost on the protecting window and hence in the field of view of the camera, which may negatively affect the correct operation of the camera, and hence of the driver-assistance system.

According to another solution, the camera is arranged in a protecting device. However, such a protecting device is very bulky to install. As is known, it is constantly sought to decrease bulk in the automotive field, and more particularly in the field of driver assistance. Furthermore, this protecting device does not possess any means for preventing the formation of condensation or frost in the field of view of the camera.

According to yet another solution, devices for protecting the optical sensors include an element upstream of the optic, rotated by an actuator, allowing grime to be removed by virtue of the centrifugal force due to the rotation of this element of the protecting device. However, such protecting devices do not possess any means for preventing the formation of condensation or frost in the field of view of the optical sensor.

The object of the present invention is to overcome, at least in part, the drawbacks of the prior art mentioned above by providing a device for protecting an optical sensor allowing the protection from the deposition of grime on the optical sensor to be improved while preventing the formation of condensation or frost in the field of view of the optical sensor.

One subject of the present invention is therefore a device for protecting an optical sensor of a driver-assistance system for a motor vehicle, the optical sensor comprising an optic, and the protecting device including:
an optical element that is configured to be positioned upstream of the optic of the optical sensor and mounted so as to be movable about an axis of rotation; and
an actuator that is configured to rotate the optical element, the protecting device further including:
at least one heating component that is configured to heat the optical element so as to defog or defrost this optical element.

The heating component allows the formation of condensation or frost in the field of view of the optical sensor to be prevented, thereby allowing the optical sensor to maintain good operating conditions regardless of the meteorological or climatic conditions.

Advantageously, the protecting device further includes an induction system that is configured to supply power to the heating component.

The use of an induction system makes it possible to limit the operating noise of the power supply of the heating component, as well as the electromagnetic noise that could interfere with, and in particular deform, the images captured by the optical sensor. Moreover, the use of an induction system allows current to be transferred wirelessly to supply power to the heating component.

The protecting device according to the present invention may further comprise one or more of the following features, taken alone or in combination:

The induction system includes a fixed primary circuit and a secondary circuit that is movable with respect to the primary circuit about the axis of rotation.

The actuator includes a stator and a rotor that is movable with respect to the stator, the primary circuit being rigidly connected to the stator and the secondary circuit being rigidly connected to the rotor.

The induction system is positioned opposite the optical element on the protecting device.

According to a first embodiment, the secondary circuit is positioned downstream of the optical element and the primary circuit is positioned downstream of the secondary circuit.

According to a second embodiment, the primary circuit is positioned downstream of the optical element and upstream of the secondary circuit. The terms “upstream” and “downstream” are defined with respect to the direction of propagation of the light rays into the optical sensor.

According to one particular embodiment, the primary circuit and the secondary circuit are coils.

According to one variant, the at least one heating component is connected directly to the secondary induction circuit.

According to another variant, the at least one heating component is connected to the secondary induction circuit using at least one electrical conductor, in particular an electrical wire.

The induction system is separate from the actuator.

The at least one heating component extends at least partly over a surface that is intended to be in the field of view of the optical sensor.

The at least one heating component rotates as one with the optical element. The use of an induction system to supply power to the heating component allows it to be supplied with electrical power even if the heating component is rotating.

According to a first embodiment, the optical element has an inner surface that is intended to be positioned facing the optical sensor and the at least one heating component is positioned facing the inner surface of the optical element.

According to a second embodiment, the at least one heating component is positioned on an inner surface or on an outer surface of the optical element.

According to a third embodiment, the at least one heating component and the optical element form a single part.

The at least one heating component may be chosen from a resistor or a filament.

According to one aspect, the at least one heating component comprises a plurality of filaments or resistors.

According to this aspect, the filaments or resistors are positioned in series parallel to one another.

Again according to this aspect, the filaments or resistors are positioned perpendicularly to an optical axis of the optical element.

The optical axis and the axis of rotation of the optical element are coincident.

According to one particular embodiment, the at least one heating component is transparent.

The protecting device may include two assembled separate subassemblies, namely:
a first subassembly is movably mounted so as to rotate about the axis of rotation and including the optical element, and the at least one heating component; and
a second subassembly including the actuator that is configured to move the first subassembly, and the induction system.

The first subassembly may further include a housing that is configured to accommodate the optical sensor, at least in part.

Another subject of the present invention is a driver-assistance system comprising an optical sensor having an optic, and further including a protecting device such as described above.

The protecting device makes it possible to ensure good operating conditions for the driver-assistance system by removing grime that may be deposited on the optical element by virtue of the rotation thereof and also prevents the formation of condensation or frost on this optical element by virtue of the presence of the heating component.

The driver-assistance system may further include one or more of the following features, taken alone or in combination:

The optical axis of the optical sensor is coincident with the axis of rotation of the optical element.

The driver-assistance system further includes an electronic control unit that is linked to the primary circuit, said electronic control unit being configured to drive the induction system of the at least one heating component.

The electronic control unit is configured to activate the induction system so as to trigger the supply of power to the at least one heating component, in order to maintain the temperature of the optical element above a predefined temperature, and in particular above a dew point.

According to one embodiment, the driver-assistance system comprises at least one temperature-measuring sensor and the electronic control unit is configured to activate the induction system so as to trigger the supply of power to the at least one heating component when the temperature measured by said temperature-measuring sensor is below a predetermined temperature, and preferably below 4° C.

According to a first variant of this embodiment, the temperature-measuring sensor is configured to measure a temperature inside the first subassembly of the protecting device, and the electronic control unit is configured to trigger the supply of power to the induction system when the thermal sensor measures a temperature inside the first subassembly of the protecting device that is lower than the predetermined temperature.

According to a second variant of this embodiment, the temperature-measuring sensor is configured to measure the temperature outside the motor vehicle, the electronic control unit being configured to trigger the supply of power to the induction system when the temperature-measuring sensor measures a temperature outside the vehicle that is lower than the predetermined temperature.

According to another embodiment, the electronic control unit further comprises image-processing means that are configured to detect a deterioration in the image transmitted by the optical sensor, the electronic control unit being configured to activate the induction system so as to trigger the supply of power to the at least one heating element according to the detected deterioration in the image.

Other advantages and features of the present invention will become more clearly apparent on reading the following description, provided by way of nonlimiting illustration, and the appended drawings, in which:

FIG. 1 is a schematic representation in partial longitudinal section of a driver-assistance system;

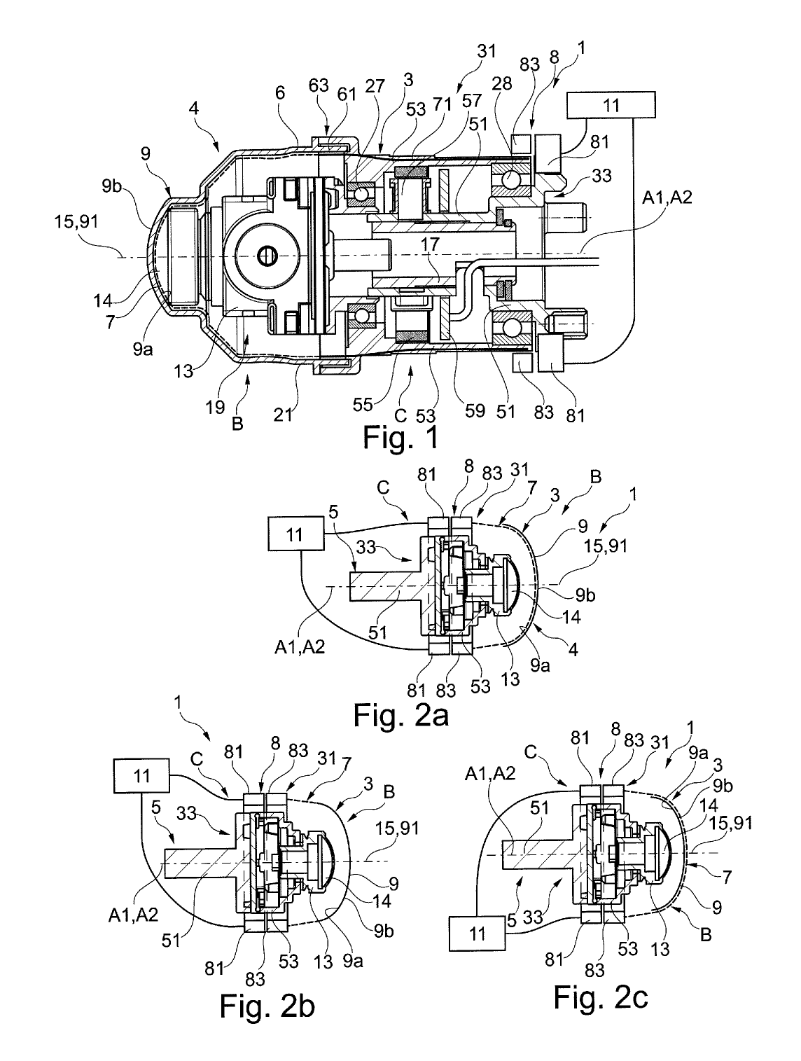

FIG. 2A is a simplified longitudinal schematic representation partially showing a heating component and an induction system for supplying power to the heating component according to a first embodiment for the driver-assistance system of FIG. 1;

FIG. 2B is a simplified longitudinal schematic representation partially showing the heating component and the induction system for supplying power to the heating component according to a second embodiment for the driver-assistance system of FIG. 1;

FIG. 2C is a simplified longitudinal schematic representation partially showing the heating component and the induction system for supplying power to the heating component according to a third embodiment for the driver-assistance system of FIG. 1; and

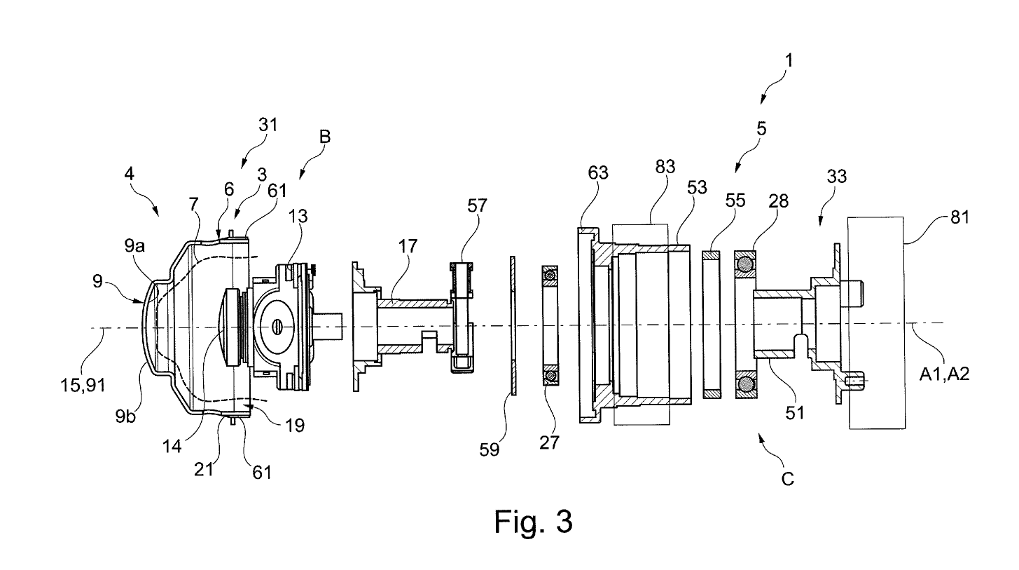

FIG. 3 is an exploded schematic representation of the driver-assistance system of FIG. 1.

In these figures, identical elements carry the same numerical references.

The following embodiments are examples. Although the description refers to one or more embodiments, this does not necessarily mean that each reference relates to the same embodiment, or that the features apply to just one embodiment. Single features of various embodiments can also be combined or interchanged in order to create other embodiments.

In the following description, reference is made to a first and to a second subassembly. The index is simply used to differentiate and denote elements that are similar but not identical. This indexing does not imply a priority of one element with respect to another and such denominations may easily be interchanged without departing from the scope of the present description. This indexing also does not imply an order in time for example for assessing the structure of the device for protecting an optical sensor, or else the arrangement of the various elements forming a driver-assistance system.

In the following description, the expression “front of the motor vehicle” corresponds to the face of the motor vehicle that is exposed to the airflow during the normal operation of the motor vehicle, this is in particular the face having the headlamps. In contrast, the term “back of the motor vehicle” is understood to mean the face of the motor vehicle opposite the front face.

Furthermore, the term “upstream” is defined, in the following description, by the direction of the light rays, i.e. from the outside into the optical sensor. A first element positioned upstream of a second element is then located in front of the second element in the direction of propagation of the light rays into the optical sensor. Similarly, the term “downstream” in the following description is also defined according to the direction of propagation of the light rays into the optical sensor. Thus, a first element positioned downstream of a second element is then located behind the second element in the direction of propagation of the light rays into the optical sensor.

Moreover, the term “grime” is understood to mean, in the following description, water drops or water stains present on the optical element, or else organic pollutants such as insects for example or inorganic pollutants such as mud for example, or else a combination of these various elements.

Additionally, the term “dew point” is understood to mean, in the following description, the lowest temperature to which an air mass may be subjected, at given pressure and humidity, without the formation of liquid water by saturation taking place. By way of nonexhaustive example, this dew point is of the order of 4° C. for a humidity of 70% in the Europe area.

Next, the term “transparent” is understood to mean, in the following description, a light-transmitting material through which objects are clearly visible, in particular objects positioned outside the motor vehicle, the image of which is captured by the optical sensor. In particular, a transparent material in the following description may be coloured or colourless.

With reference to FIGS. 1 to 3, a driver-assistance system 1 for a motor vehicle comprising an optical sensor 13 is shown. The driver-assistance system 1 further includes a device 3 for protecting the optical sensor 13.

The optical sensor 13 may for example be an image-capturing optical sensor 13 such as a camera. It may for example be a CCD (charge-coupled device) sensor or a CMOS sensor including a matrix array of miniature photodiodes.

The optical sensor 13 includes an optic 14 having an optical axis 15. The optic 14 may for example be an objective. An objective may include at least one lens, and in particular, depending on the field of view and the resolution of the optical sensor 13, a plurality of lenses, for example between two and ten lenses, generally four or five lenses, or even ten lenses in the case of a fish-eye 14. At least one of the lenses of the optic 14 is for example convex (curved), its convexity being oriented toward the exterior of the optical sensor 13, for a fish-eye 14 for example.

Moreover, a holder 17 for the optical sensor 13 may be provided. This holder 17 is arranged behind the optical sensor 13 on the side opposite to the optic 14. In the embodiment illustrated with reference to FIGS. 1 and 3, the optical sensor 13 is intended to be mounted in the protecting device 3. More precisely, the optical sensor 13 and in particular its holder 17 are intended to be fixedly mounted in the protecting device 3.

The driver-assistance system 1 may be mounted at the front of the motor vehicle level with a bumper for example. As a variant, the driver-assistance system 1 may be installed at the rear of the motor vehicle, for example level with the bumper or number plate. According to yet another variant, the driver-assistance system 1 may be mounted on the sides of the motor vehicle, for example level with the rear-view mirrors.

The driver-assistance system 1, and more particularly the device 3 for protecting the optical sensor 13, may be attached, using any technique known to a person skilled in the art, to any element of the motor vehicle, such as to a body element or to an external element such as a bumper, a rear-view mirror or a number plate. For this purpose, mention may be made, nonexhaustively, of a system of clips, a screwing system, or even an adhesive-bonding system.

With reference to FIGS. 1 and 3, the protecting device 3 includes an optical element 9 that is configured to be positioned upstream of the optic 14 of the optical sensor 13 and mounted so as to be movable about an axis of rotation A1. The protecting device 3 also includes an actuator 5 that is configured to rotate the optical element 9.

The protecting device 3 further includes at least one heating component 7 that is configured to heat the optical element 9 so as to defog or defrost this optical element 9. To supply electrical power to the heating component 7, the protecting device 3 also includes an induction system 8. The heating component 7 and the induction system 8 are described in greater detail below.

The optical element 9 is intended to protect the optic 14 of the optical sensor 13 from potential spatter with grime or solid debris that could damage this optic 14. It is therefore an element for protecting, or more precisely a mask for protecting, the optical sensor 13, and it is this protecting element 9 that is subjected to aggressions originating from the outside, i.e. to water spatter, pollutants, small pieces of stone, but also pollutant deposits or water stains. In the state in which the driver-assistance system 1 is mounted on the motor vehicle, the optic 14 and the protecting element 9 protrude from an opening made in the element of the motor vehicle. In the embodiment described here, the optical element 9 is separate from the optical sensor 13. According to one variant (not shown), the optical element 9 may be a component of the optic 14, and in particular an outer lens of the optic 14.

The optical element 9 is arranged at the front of the protecting device 3. The expression “front of the protecting device 3” is understood to mean the portion intended to be placed facing the road scene images of which the optical sensor 13 participates in capturing, when the driver-assistance system 1 is mounted on the motor vehicle. In contrast, the term “rear of the protecting device 3” is understood to mean the portion opposite the front; it is therefore the portion that is furthest from the road scene images of which the optical sensor 13 participates in capturing. Additionally, the optical element 9 is intended to be positioned upstream of the optic 14

The optical element 9 is dimensioned so as to cover all of the surface of the optic 14. The optical element 9 is therefore arranged in the field of view of the optical sensor 13. To this end, the optical element 9 is transparent in order not to decrease the effectiveness of the optical sensor 13. This optical element 9 may be made of glass or of a transparent plastic such as polycarbonate, for example. Additionally, the optical element 9 has an inner surface 9a that is positioned facing the optic 14 of the optical sensor 13 in the state in which the optical sensor 9 is mounted in the protecting device 3. This inner surface 9a is furthermore opposite an outer surface 9b.

Furthermore, at least the outer surface 9b may have one or more of the following properties: hydrophobic, infrared filter, photocatalytic, superhydrophobic, lipophobic, hydrophilic, or even superhydrophilic, stone-chip resistant, or even any other surface treatment allowing the adhesion of grime to be decreased. In particular, by virtue of the hydrophobic properties of the outer surface 9b of the optical element 9, any water droplets will run off the outer surface 9b without leaving stains because the water will not be able to adhere to this outer surface 9b. This thus allows the presence of water stains on the optical element 9, which could adversely affect correct operation of the driver-assistance system 1, to be limited. Additionally, depending on the surface treatment of the outer surface 9b, the possibility for organic or inorganic pollutants to adhere to this outer surface 9b may be limited, thereby also contributing to the correct operation of the driver-assistance system 1.

According to the illustrated embodiment, the protecting device may further include a housing 6 that is configured to accommodate the optical sensor 13, at least in part. The housing 6 and the optical element 9 form a first subassembly B.

The first subassembly B is mounted so as to be able to rotate about the axis of rotation A1. The first subassembly B therefore forms an accessory 4 for the motor vehicle, the function of which is to protect the optical sensor 13. According to the particular embodiment of FIG. 1, the optical element 9 and the housing 6 form a single part. However, according to another embodiment (not shown here), the optical element 9 and the housing 6 may be two rigidly connected but distinct parts. Furthermore, this first subassembly B, and more particularly the housing 6, also includes the at least one heating component 7.

The housing 6 is arranged so as to be rotated by the motor 5, resulting in the optical element 9 and the heating component 7 being rotated so as to allow the optical element 9 to be cleaned by centrifugal effect. The housing 6 may be a sealed housing made of any suitable material known to those skilled in the art.

Furthermore, the optical sensor 13 is at least partially mounted in the housing 6. For this purpose, the housing 6 includes a compartment 19 (visible in FIG. 1) that is configured to accommodate the optical sensor 13. More precisely, the housing 6 includes a wall 21 defining the compartment 19. According to the particular embodiment of FIG. 1, the wall 21 is generally substantially cylindrical in shape. The wall 21 and the optical element 9 may form a single part. As a variant, the wall 21 and the optical element 9 may be two rigidly connected but distinct parts. In particular, the front end of the wall 21 is rigidly connected to the optical element 9. By way of nonlimiting example, the wall 21 and the optical element 9 may be rigidly connected by ultrasonic welding, for example. Thus, the housing 6 and the optical element 9 may be one or more parts. Since the housing 6 is rigidly connected to the optical element 9, a seal-tight unit is formed that thus prevents grime from getting into the interior of the housing 6 that is intended to accommodate the optical sensor 13.

Additionally, to ensure the correct operation of the optical sensor 13, at least some elements of the first subassembly B, and preferably those positioned in the field of view of the optical sensor 13, may be partly or entirely transparent.

As a variant or in addition, the housing 6 may have, in addition to the heating component 7, anti-condensation means (not shown) such as at least one through-aperture in the housing 6 made by drilling and preferably having one or more semipermeable membranes (not shown) for example. In such a case, means for compensating for the loss of mass potentially caused by such an aperture may be provided so as not to unbalance the rotation of the optical element 9.

As mentioned above, the optical element 9 is mounted so as to rotate about the axis of rotation A1, which is coincident with the optical axis 15 of the optical sensor 13. Specifically, rotating the optical element 9 allows grime that may have been deposited on the outer surface 9b thereof to be shed by centrifugal effect. Additionally, the optical element 9 has an optical axis 91. According to the particular embodiment shown with reference to FIG. 1, the optical axis 91 and the axis of rotation A1 of the optical element 9 are coincident. Furthermore, according to this particular embodiment, the optical axis 15 of the optical sensor 13 and the axis of rotation A1 of the optical element 9 are also coincident.

In order to rotate the optical element 9, the actuator 5 may for example be a motor 5 rotating about an axis of rotation A2. Advantageously, the axis of rotation A2 may be coincident with the axis of rotation A1 and with the optical axis 15 of the optical sensor 13.

The motor 5 has a fixed stator 51 and a rotor 53 that rotates with respect to the stator 51.

In the embodiment of FIGS. 1 and 3, the rotor 53 is arranged around the stator 51. The stator 51 is therefore internal and the rotor 53 external.

According to one variant (not shown here), the stator 51 may be arranged around the rotor 53. Furthermore, the motor 5 may be arranged in the extension of the optical sensor 13. The motor 5 is advantageously hollow so as to accommodate the optical sensor 13, at least in part. In particular, according to the embodiment of FIG. 3, the hollow motor 5 may accommodate the holder 17 of the optical sensor 13. The motor 5 is for example supplied with electrical power by a power supply that is connected to the general electrical circuit of the motor vehicle. The motor may for example be a stepper motor, an actuator, a brushed or brushless DC motor, or an asynchronous motor.

By way of nonlimiting example, the motor 5 may more particularly be a brushless motor. According to the example illustrated with reference to FIGS. 1 to 3, the motor 5 comprises at least one magnet 55 that is rigidly connected to the rotor 53, and a predefined number of electromagnetic coils 57, in particular at least three electromagnetic coils 57 that are mounted on the stator 51. The electromagnetic coils 57 are intended to be supplied with power in order to allow the magnet 55 that is rigidly connected to the rotor 53 to be driven. The motor 5 comprises, for this purpose, a circuit 59 for controlling the supply of power to the electromagnetic coils 57. This control circuit 59 may be connected to an electrical-power-supply wiring harness (not shown) that is connected to the general electric circuit of the motor vehicle.

The motor 5 may have a speed of rotation comprised between 1000 and 50000 revolutions/minute, preferably between 5000 and 20000 revolutions/minute, and even more preferably between 7000 and 15000 revolutions/minute. Such speeds of rotation allow any grime that has been deposited on the optical element 9 to be removed via a centrifugal effect and thus allow the optic 14 of the optical sensor 13 to be kept clean in order to ensure the driver-assistance system 1 operates optimally.

The protecting device 3 therefore includes a movable portion 31, also called the rotating portion, and a fixed portion 33. The movable portion 31 comprises at least the rotor 53 of the motor 5, and at least the optical element 9. The fixed portion 33 comprises, for its part, at least the stator 51 of the motor 5.

In the particular example shown with reference to FIGS. 1 and 3, the fixed portion 33 includes the fixed holder 17 of the optical sensor 13. This holder 17 is in particular attached to the stator 51.

According to the embodiment of FIGS. 1 and 3, the protecting device 3 may comprise one or more bearings 27, 28 that are arranged between the movable portion 31 and the fixed portion 33. The bearings 27, 28 are generally substantially ring-shaped and are preferably arranged concentrically with the motor 5.

According to the particular embodiment of FIG. 1, one of the bearings, for example the bearing 27, may be placed between the rotor 53 and a portion, in particular a front portion, of the holder 17 of the optical sensor 13. The other bearing, the bearing 28 in this example, is placed between the rotor 53 and the stator 51 of the motor 5. Alternatively, the bearings 27, 28 may be arranged between the rotor 53 and the stator 51. They may be mechanical and/or magnetic bearings. The bearings 27, 28 are shown here as ball bearings. However, other variants are envisageable.

The motor 5 forms part of a second subassembly C. The protecting device 3 may include the first B and the second C separate subassemblies assembled together. In other words, the two subassemblies B and C form, when they are assembled, the protecting device 3. Advantageously, the two subassemblies B and C are aligned along the optical axis 15 of the optical sensor 13.

The second subassembly C also has the induction system 8 that is configured to supply power to the heating component 7 so as to defog or defrost the optical element 9.

To rotate the first subassembly B, the motor 5 is coupled to the housing 6 so as to rotate the housing 6 and hence the optical element 9 about the axis of rotation A1. As mentioned above with reference to FIGS. 1 and 3, the axis of rotation A2 of the motor 5 and the axis of rotation A1 of the optical element 9 are coincident with the optical axis 15 of the optical sensor 13.

Furthermore, the bearings 27, 28, the operation of which has been explained above, may be borne by the second subassembly C.

Furthermore, the first subassembly B includes first assembling means 61 that are intended to cooperate with second, complementary assembling means 63 borne by the second subassembly C so as to form the driver-assistance system 1 once the optical sensor 13 has been installed in the holder 17 positioned in the second subassembly C. According to the embodiment of FIGS. 1 and 3, the first 61 and second 63 assembling means join the first B and second C subassemblies together at their periphery. More particularly, the first 61 and second 63 assembling means are configured to seal off the inside of the housing 6 so as to prevent the optic 14 being contaminated by external grime such as organic or inorganic pollutants, or else water stains for example.

With reference to FIGS. 1 to 3, the at least one heating component 7 is chosen from a resistor or a filament. More particularly, the heating component 7 comprises a plurality of filaments or resistors that are positioned in series parallel to one another. Furthermore, the filaments or resistors may be positioned perpendicularly to the optical axis 91 of the optical element 9.

Advantageously, the at least one heating component 7 is transparent. The use of a transparent material for the heating component 7 allows any deterioration in the image captured by the optical sensor 13 due to the presence, and in particular to the rotation, of the heating component 7 to be avoided.

To ensure that the driver-assistance system 1 operates correctly, the at least one heating component 7 extends at least partially into the field of view of the optical sensor 13. In particular, the heating component 7 may extend at least partly over a surface that is intended to be in the field of view of the optical sensor 13. The heating component 7 is configured to heat the optical element 9, thus preventing the formation of condensation or frost on a surface of the optical element 9.

According to the particular embodiment of FIG. 2A, the at least one heating component 7 may be positioned facing the inner surface 9a of the optical element 9 and is distinct from the optical element 9. According to this particular embodiment, the heating component 7 heats the space comprised between the optic 14 of the optical sensor 13 and the inner surface 9a of the optical element 9, thus preventing the formation of condensation or frost on the optical element and therefore ensuring the correct operation of the driver-assistance system 1 regardless of the meteorological or climatic conditions.

According to the particular embodiment of FIG. 2B, the at least one heating component 7 and the optical element 9 may form a single part. Thus, the heating component 7 and the optical element 9 are merged.

According to the particular embodiment of FIG. 2C, the at least one heating component 7 may be positioned on the inner surface 9a or on the outer surface 9b of the optical element 9. The heating component 7 and the optical element 9 according to this particular embodiment are therefore two distinct elements making contact with one another. According to this particular embodiment, the heating component 7 is positioned on the inner surface 9a of the optical element 9 so as to provide protection from potential spatter with solid debris that could damage it and hence negatively affect the correct operation thereof. Advantageously, arranging the heating component 7 in such a way makes it possible to speed up the defrosting or defogging of the optical element 9 since the heating component 7 is placed in contact with the optical element 9, which makes it possible to limit the energy losses related in particular to the dissipation of thermal energy into the air.

According to the particular embodiment shown with reference to FIGS. 2A to 2C, the at least one heating component 7 is connected directly to the secondary induction circuit 83.

According to one variant shown with reference to FIG. 1, the at least one heating component 7 is connected to the secondary induction circuit 83 using at least one electrical conductor 71, in particular an electrical wire. The use of the electrical conductor 71 depends on the positioning of the secondary circuit 83 in the protecting device 3. Specifically, if the secondary circuit is positioned close enough to the optical element 9, the use of the electrical conductor 71 is not absolutely necessary.

The induction system 8 includes a fixed primary circuit 81 and a secondary circuit 83 that is rotatably movable with respect to the primary circuit 81 about the axis of rotation A1. According to the particular embodiment of FIGS. 1 and 3, the primary circuit 81 is rigidly connected to the stator 51 and the secondary circuit 83 is rigidly connected to the rotor 53.

Furthermore, the induction system 8 is, in the described example, distinct from the actuator 5 rotating the optical element 9.

Moreover, the primary circuit 81 and the secondary circuit 83 may be coils.

With reference to FIGS. 1 and 3, the induction system 8 is positioned opposite the optical element 9 on the protecting device 3. Furthermore, the coils making up the primary circuit 81 and the secondary circuit 83 are advantageously positioned in the near field. More particularly, according to the embodiment of FIG. 1, the primary circuit 81 is positioned on the stator 51 and the secondary circuit 83 is positioned around the bearing 28.

According to one variant (not shown here), the coil corresponding to the secondary circuit 83 may be remote from the coil making up the primary circuit 81. For this, the coils making up the primary circuit 81 and the secondary circuit 83 must exhibit sufficient electromotive force.

Advantageously, the use of an induction system 8 to supply power to the heating component 7 makes it possible to omit a wired connection from the heating component to a fixed power supply source, thereby addressing the issue of the rotation of the optical element 9, the heating component 7 rotating as one with the optical element 9. Furthermore, the use of the induction system 8 makes it possible to limit the operating noise of the protecting device 3, in particular when it is necessary to defog or defrost the optical element 9. Additionally, the use of an induction system 8 also makes it possible to limit the electromagnetic operating noise of the heating component 7, this electromagnetic noise potentially interfering with the image captured by the optical sensor 13 and hence negatively affecting correct operation of the driver-assistance system 1.

According to the particular embodiments shown with reference to FIGS. 1 to 3, the primary induction circuit 81 is electrically connected to an external electricity source (not shown) that is intended to supply it with power so as to allow energy to be transferred by induction to supply power to the heating component 7.

According to one variant (not shown here), the primary induction circuit 81 does not have to be linked to an external electricity source. According to this variant, the secondary induction circuit 83 is supplied with power according to the principle of Lenz's law by virtue of the current induced by the actuator 5.

According to the particular embodiment of FIGS. 1 and 3, in the case in which the movable portion 31 is positioned upstream of the fixed portion 33, the secondary circuit 83 is positioned downstream of the optical element 9 and the primary circuit 81 is positioned downstream of the secondary circuit 83.

According to one variant (not shown), in the case in which the fixed portion 33, and in particular the stator 51, is positioned upstream of the movable portion 31, and more particularly the rotor 53, the primary circuit 81 is positioned downstream of the optical element 9 and upstream of the secondary circuit 83.

With reference to FIGS. 1 to 2C, the driver-assistance system 1 further includes an electronic control unit 11 that is linked to the primary circuit 81. The electronic control unit 11 is configured to drive the induction system 8 of the at least one heating component 7. More specifically, the electronic control unit 11 is configured to activate the induction system 8, and more particularly the primary circuit 81, so as to trigger the supply of power to the at least one heating component 7. Supplying power to the heating component 7 makes it possible to maintain the temperature of the optical element 9 above a predefined temperature, and in particular above a dew point, so as to prevent the formation of condensation or frost on the optical element 9. Specifically, it is the dew point that will trigger the formation in particular of condensation on the optical element 9. However, if the temperature inside the protecting device 3 remains above the dew point, the formation of condensation may thus be prevented. Moreover, if the temperature of the optical element 9 remains above the dew point, which is generally a positive temperature, the formation of frost on the optical element 9 may also be prevented.

Furthermore, the electronic control unit 11 driving the heating component 7 may have different operating modes, and in particular a preventative (open-loop) operating mode or a direct (closed-loop) operating mode, explained below.

When the driver-assistance system 1 operates in open-loop mode, it comprises at least one temperature-measuring sensor. According to this embodiment, the electronic control unit 11 is configured to activate the induction system 8 so as to trigger the supply of power to the at least one heating component 7 when the temperature measured by said temperature-measuring sensor is below a predetermined temperature, and preferably below 4° C. Thus, if the temperature is lower than 4° C., the primary circuit 81 is activated so as to supply power to the heating component 7 and hence to heat the optical element 9 in order to prevent the formation of condensation or frost on the optical element 9 by maintaining the temperature of the optical element 9 above the dew point, thus ensuring the correct operation of the driver-assistance system 1 regardless of the meteorological or climatic conditions.

According to a first variant, the temperature-measuring sensor is configured to measure a temperature inside the first subassembly B of the protecting device 3. According to this first variant, the electronic control unit 11 is configured to trigger the supply of power to the induction system 8 when the temperature-measuring sensor measures a temperature inside the first subassembly B of the protecting device 3 that is lower than the predetermined temperature.

According to a second variant, the temperature-measuring sensor is configured to measure the temperature outside the motor vehicle. According to this second variant, the electronic control unit 11 is configured to trigger the supply of power to the induction system 8 when the temperature-measuring sensor measures a temperature outside the vehicle that is lower than a predetermined temperature. Such a temperature-measuring sensor may correspond to the temperature sensor used by the motor vehicle to warn the driver of the possibility of ice on the road for example.

Advantageously, this first strategy corresponding to an open-loop operating mode, or preventative strategy, is straightforward to implement.

As an alternative or in addition, the driver-assistance system 1 may operate in closed-loop mode. According to this alternative, the electronic control unit 11 further comprises image-processing means that are configured to detect a deterioration in the image transmitted by the optical sensor 13. The electronic control unit 11 is configured to activate the induction system 8 so as to trigger the supply of power to the at least one heating element 7 according to the detected deterioration in the image. Specifically, if condensation forms on the optical element 9, the images captured by the optical sensor 13 are subject to deterioration, in particular in terms of clarity. Thus, the electronic control unit 11, using the image-processing means, detects such a formation of condensation and may trigger the supply of power to the primary circuit 81 in order to trigger the heating of the heating component 7 and hence the heating of the optical element 9 so as to defog or defrost it.

Advantageously, this second strategy corresponding to a closed-loop operating mode allows the operation of the heating component 7 to be triggered only when necessary, i.e. when the quality of the images captured by the optical sensor 13 have deteriorated.

The embodiments described above are examples given by way of nonlimiting illustration. Furthermore, it is entirely possible for a person skilled in the art to use two temperature-measuring sensors, one corresponding to the temperature-measuring sensor of the motor vehicle, and the other being positioned inside the compartment 19 defined by the second subassembly B, without departing from the scope of the present invention. Similarly, a person skilled in the art could combine the open-loop and closed-loop operating modes of the electronic control unit 11 without departing from the scope of the present invention.

Thus, it is possible to improve the operation of a driver-assistance system 1 regardless of the meteorological or climatic conditions by virtue of the presence of a protecting device 3 having an optical element 9 that is installed in a rotary manner so as to shed potential grime that might be deposited thereon by centrifugal effect, the protecting device 3 further having a heating component 7 that is supplied with power by an induction system 8 making it possible to prevent the formation of or to remove condensation or frost on/from the optical element 9.

1. A device for protecting an optical sensor of a driver-assistance system for a motor vehicle, the optical sensor comprising an optic, and the protecting device including:
an optical element that is configured to be positioned upstream of the optic of the optical sensor and mounted so as to be movable about an axis of rotation; and
an actuator that is configured to rotate the optical element;
at least one heating component that is configured to heat the optical element so as to defog or defrost this optical element; and
an induction system that is configured to supply power to the heating component.

2. The device for protecting an optical sensor according to claim 1, wherein the induction system includes a fixed primary circuit and a secondary circuit that is movable with respect to the primary circuit about the axis of rotation.

3. The device for protecting an optical sensor according to claim 2, wherein the actuator includes a stator and a rotor that is movable with respect to the stator, and the primary circuit is rigidly connected to the stator and the secondary circuit is rigidly connected to the rotor.

4. The device for protecting an optical sensor according to claim 2, wherein the primary circuit and secondary circuit are coils.

5. The device for protecting an optical sensor according to claim 1, wherein the at least one heating component extends at least partly over a surface that is intended to be in the field of view of the optical sensor.

6. The device for protecting an optical sensor according to claim 1, wherein the optical element has an inner surface that is positioned facing the optical sensor and the at least one heating component is positioned facing the inner surface of the optical element.

7. The device according to claim 1, wherein the at least one heating component is positioned on an inner surface or on an outer surface of the optical element.

8. The device according to claim 1, wherein the at least one heating component and the optical element form a single part.

9. The device for protecting an optical sensor according to claim 1, wherein the at least one heating component is a resistor or a filament.

10. The device according to claim 1, wherein the at least one heating component is transparent.

11. A driver-assistance system comprising an optical sensor having an optic; and a protecting device according to claim 1.

12. The driver-assistance system according to claim 11, further comprising an electronic control unit that is linked to the primary circuit, said electronic control unit being configured to drive the induction system of the at least one heating component.
